(19) United States
(12) Patent Application Publication
(10) Pub. No.: US 2005/0265316 A1
(43) Pub. Date: Dec. 1, 2005

(54) Audio distribution

(76) Inventors: Hong Liu, Dartmouth, MA (US); Adam Carvalho, Swansca, MA (US); Steve M. Mooney JR., Wickford, RI (US); Joel McNamee, Salem, MA (US); Christopher Yafrate, Raynham, MA (US)

Correspondence Address: FISH & RICHARDSON PC, P.O. BOX 1022, MINNEAPOLIS, MN, 55440-1022, US

(21) Appl. No.: 11/123,957

(22) Filed: May 6, 2005

Related U.S. Application Data
(60) Provisional application No. 60/568,887, filed on May 7, 2004.

(51) Int. Cl. H04L 12/28

(52) U.S. Cl. 370/352

(57) ABSTRACT

Methods and apparatus, including computer program products, for audio distribution. In one aspect, a system includes a client, the client uploading a set of audio files to a server, and the server capable of maintaining multiple sets of audio files and generating multiple unique streams of the audio files to one or more audio receivers over a wireless interface using a streaming protocol.

### CROSS-REFERENCE TO RELATED APPLICATIONS

This application claims priority based on U.S. Provisional Patent Application No. 60/568,887 for AUDIO DISTRIBUTION, filed May 7, 2004, the disclosure of which is incorporated here by reference in its entirety.

### BACKGROUND OF THE INVENTION

The present invention relates to data processing by digital computer, and more particularly to audio distribution.

Different technologies can be used to distribute and stream audio files, such as MPEG-1 Audio Layer-3s (MP3s), to end users. These technologies include frequency division multiple access (FDMA), code division multiple access (CDMA), and a wireless network (WLAN). It is also possible to use standard radio frequency (RF) transmitters and receivers. This type of system typically uses FDMA. There are several disadvantages to this type of system, particularly when copyrighted material is being transmitted. For example, some type of signal security is necessary in order to prevent users from receiving streams that are not their own. Additionally, there is limited frequency space available. Each user requires dedicated channels different than every other user.

Wired end user receiving devices, such as portable compact disc (CD) players, MP3 players or radios, can provide a customized music experience but have associated pitfalls. For example, wires can easily interfere with the end user and bulky devices are often awkward to carry or transport during physical activity. Receiving devices can also fall to the ground, causing them to malfunction.

### SUMMARY OF THE INVENTION

The present invention provides methods and apparatus, including computer program products, for audio distribution.

In general, in one aspect, the invention features a protocol for communicating between an audio receiver and a server located in a local area network (LAN) including an 8-bit sequence number field, an 8-bit audio receiver identification field, and an 8-bit command field, the command bit including a 4-bit options field and a 4-bit command field.

In embodiments, the sequence number field can handle packet loss, duplicate control packets, out-of-band negative acknowledgments (NAKs), and retransmission of media data packets. The audio receiver identification can be used for the server to offer multiple audio receivers with individual media streams.

The 4-bit command field can include receiver setup commands, receiver playback function commands and data transfer commands. The 4-bit command field can be a five second skip forward command. The 4-bit command field can be an initialize receiver command. The 4-bit command field can be a five second skip backward command. The 4-bit command field can be a data request command. The 4-bit command field can be a next track command. The 4-bit command field can be a receiver terminate stream command. The 4-bit command field can be a previous track command. The 4-bit command field can be a server terminate stream command. The 4-bit command field can be a pause/resume command. The 4-bit command field can be a server initiate sequence command. The 4-bit command field can be a data request notification command. The 4-bit command field can be a lost packet notification command.

In another aspect, the invention features a system including multiple audio receivers, multiple clients, each of the clients uploading a set of audio files to a server, and the server maintaining multiple sets of audio files and generating multiple streams of the audio files to the multiple audio receivers over a wireless interface using a streaming protocol.

In embodiments, the multiple audio receivers can include low processor speed and small memory size. The multiple clients can communicate with the server to manipulate media under individual accounts. The server can include an Internet connection to communicate with the multiple clients and a wireless local area network (LAN) to communicate with the multiple audio receivers.

The server can include processes to maintain the audio files and play lists for users. The server can reside in a local area network (LAN).

In another aspect, the invention features a system including a server, the server streaming audio files to multiple different specific low memory and low speed devices over a wireless interface using a streaming protocol.

In embodiments, the devices can be portable listening devices. The devices can include a small amount of memory or buffer space.

The details of one or more implementations of the invention are set forth in the accompanying drawings and the description below. Further features, aspects, and advantages of the invention will become apparent from the description, the drawings, and the claims.

### BRIEF DESCRIPTION OF THE DRAWINGS

FIG. 1 is block diagram of a system.

FIG. 2 is a block diagram of a client.

FIG. 3 is a block diagram of a server.

FIG. 4 is a block diagram of a receiving device.

FIG. 5 is a block diagram of an Air2Ear Streaming Protocol (ASP) control packet.

FIG. 6 is a table of commands.

FIG. 7A is an interaction diagram.

FIG. 7B is an interaction diagram.

FIG. 8 is a Graphical User Interface (GUI).

FIG. 9 is a GUI.

FIG. 10 is a GUI.

FIG. 11 is a GUI.

FIG. 12 is a block diagram.

FIG. 13 is a block diagram.

FIG. 14 is a block diagram.

FIG. 15 is a block diagram.

FIG. 16 is a block diagram.

FIG. 17 is a block diagram.

FIG. 18 is a block diagram.

FIG. 19 is a GUI.

Like reference numbers and designations in the various drawings indicate like.

### DETAILED DESCRIPTION

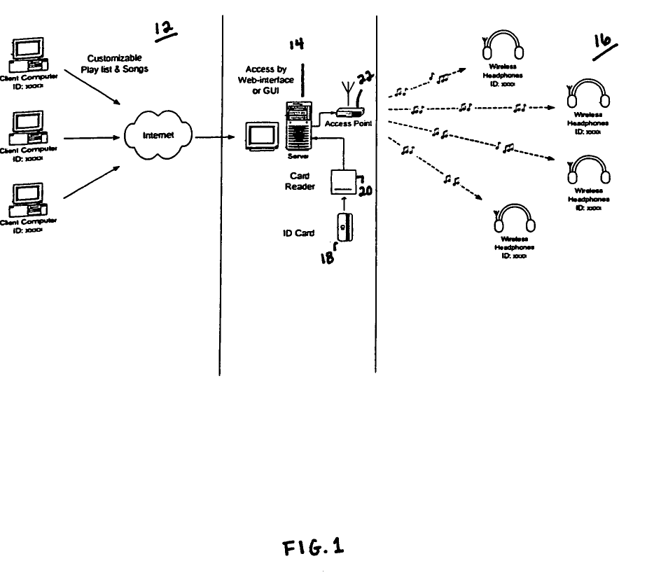

As shown in FIG. 1, a system 10 in accordance with the invention includes three interacting modules, a client 12, a server 14 and a receiving device 16, such as wireless headphones. The client 12 organizes, uploads, retrieves, and/or modifies a customizable list of audio files (e.g., play list).

The server 14 performs two major functions. A first function is to receive and store audio files, such as MP3 files, from the client 12. A second function is to stream the audio files using a protocol described herein to specific receiving devices 16, such as wireless headphones.

The receiving devices 16 receive and playback audio streams for an end user.

In one example, a user transfers a desired play list and audio file to the server 14 using a graphical user interface (GUI) or web interface. Using an identification (ID) card 18 and card swipe through a card reader 20, the user is logged into the server 14, and the play list assigned to a specific receiving device 16. The audio associated with the play list is streamed out wirelessly from the server 14 through an access point 22 to a specific receiving device 16.

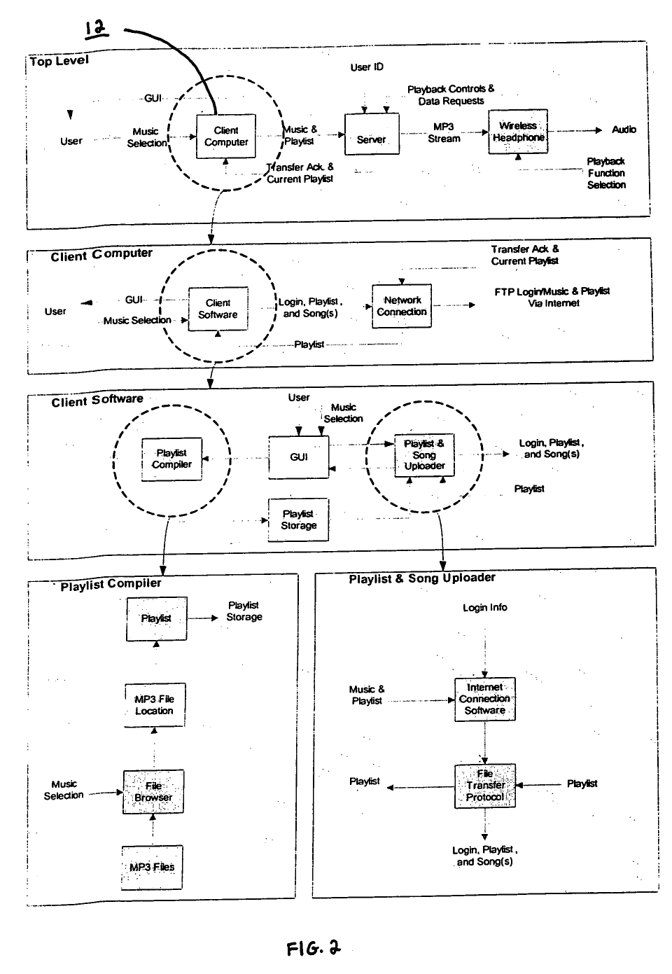

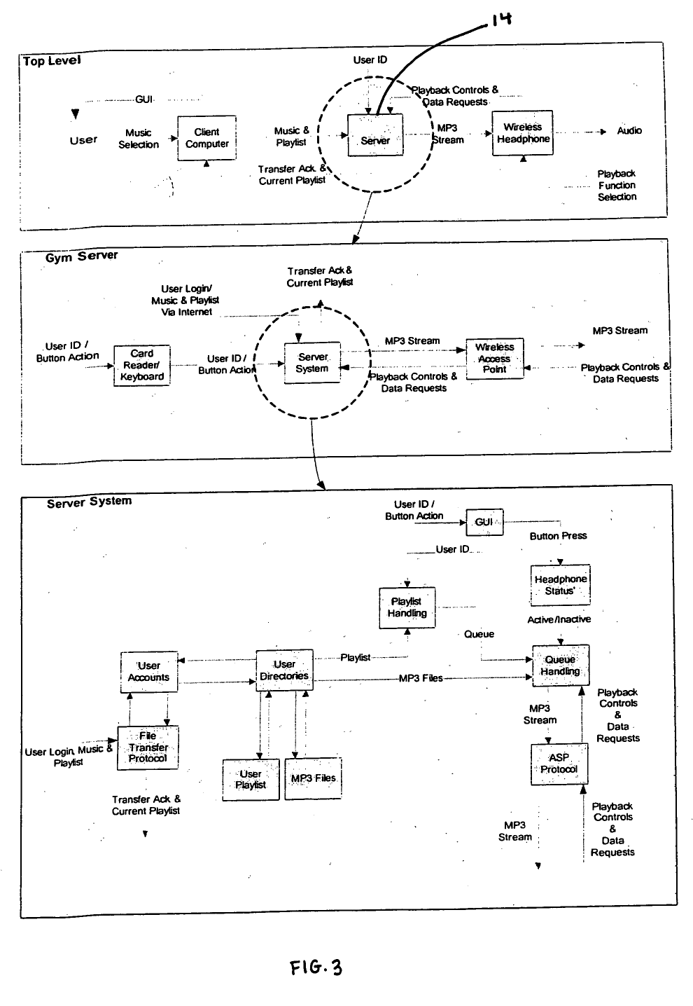

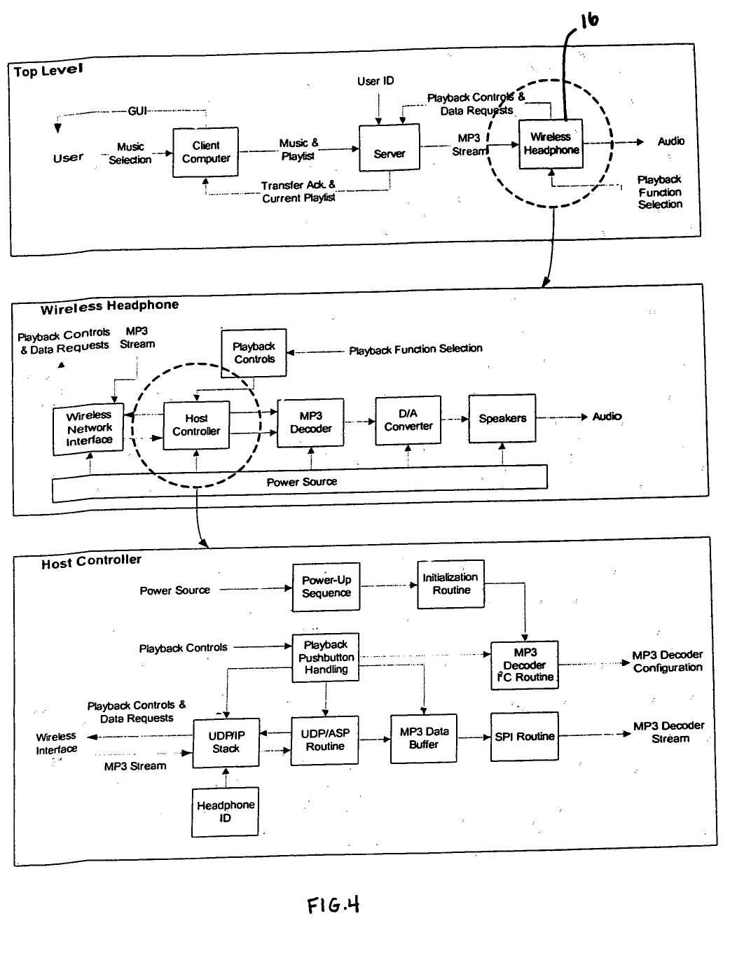

As shown in FIGS. 2, 3 and 4, the client 12, server 14 and receiving devices 16 include underlying components and functions. The arrows indicate communication paths of each interacting module, i.e., client 12, server 14, and receiving device 16.

In one particular example, streaming of audio files between the server 14 and receiving devices 16 uses a wireless technology. For example, a wireless router can be used to stream the audio files to the receiving devices 16. This is generally simpler than generating a FDMA or CDMA interface to either transmitter.

In this example, Wireless Ethernet standard IEEE 802.11b is chosen because of the availability of development kits and documentation. Commercially available hardware allows easy implementation of a wireless network based on the IEEE 802.11b standard. One appealing characteristic of the IEEE 802.11b standard is that the wireless hardware can be directly interfaced with a computer.

Alternatives exist for how the end user is identified. For example, a computer can be interfaced with the card reader 20 or the end users can simply type in an identification (ID) through an input device, such as a keyboard.

There are a number of different programming languages that can be used to implement the client 12. Example languages include Java, Visual Basic (VB), or any web-based languages such as VBScript or PHP. VBScript is an interpreted script language from Microsoft Corporation that is a subset of Microsoft's visual basic programming language designed for interpretation by Web browsers. PHP is a script language and interpreter that is freely available and used primarily on Linux Web servers. Java allows the client 12 to run on a number of different operating systems, whereas VB only runs on a Windows-based system. A web-based interface allows for use on all operating systems. In production, using Java or any of the web-based languages is preferred because it can service the largest number of end users due to the multiple platform adaptability.

The server 14 stores a play list and corresponding audio files for each end user. Two example methods of storing these audio files are Oracle database server and Windows directory structure. Using Oracle database server, simple queries for audio files and play lists are performed along with more difficult functions that are implemented using Oracle SQL.

Using Windows directory structure, each end user is given their own individual folder, which contains all their audio files and their play list(s). Both of these methods allow for the storage of audio files for individual end users.

The server 14 uses a protocol for communicating with the receiving devices 16. The real time transfer protocol (RTP) standard streaming protocol family such as real time streaming protocol (RTSP) along with RTP and real time control protocol (RTCP) can be used. However, the overhead associated with them is large for receiving devices 16 to accommodate. Many functions these protocols provide to support various multimedia applications over wide area networks are not necessary for the unique environment where system 10 resides. Therefore, we developed a new protocol, called Air2Ear Streaming Protocol (ASP), that is “lightweight” with good core functionality.

As described above, the ASP protocol is used for communication between each receiving device 16 and the server 14. Packets are sent between the server 14 and receiving devices 16 on specified ports. These packets are used to start, maintain, or terminate a stream. The server 14 processes requests from all receiving devices 16 and sends feedback to the requesting receiving device 16.

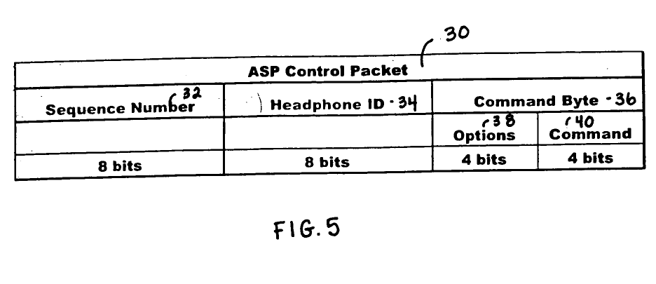

As shown in FIG. 5, an exemplary ASP control packet 30 includes a sequence number field 32, a receiving device ID field 34 and a control byte field 36. The control byte field 36 includes 4 bits referred to as an options field 38 and 4 bits referred to as a command field 40.

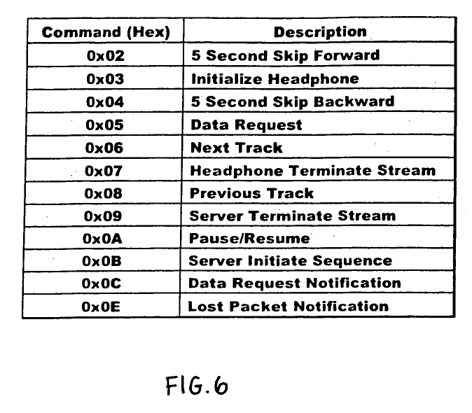

As shown in FIG. 6, the command field is used to specify a command. Exemplary commands are shown.

The options field 38 allows for more commands to be implemented, if necessary. For example, the options field 38 can be used for specifying a size of data packets when they are requested.

The receiving device ID field 34 can contain a ranges of values from 0 to 256, enabling a large number of receiving devices 16 to be active at one time. The receiving device ID is specified by the server 14, and is given to a receiving device (0cXX1D0B) after receiving an initialize sequence (0xXXXX03) from that specific receiving device 16. The specific receiving device 16 stores the ID, and uses it statically to identify itself on every subsequent request.

Once a receiving device 16 is initialized, its user can request services by sending the following commands to the server control port:
a. Fast forward—skips five seconds of a currently playing song and resumes
b. Rewind—goes back five seconds in a currently playing song and resumes
c. Next track—increments along a user's play list to a next song and plays the song
d. Previous track—skips back to a previous song in the play list and starts playing
e. Pause/resume—halts the stream. Sending this command a second time enables continued playing

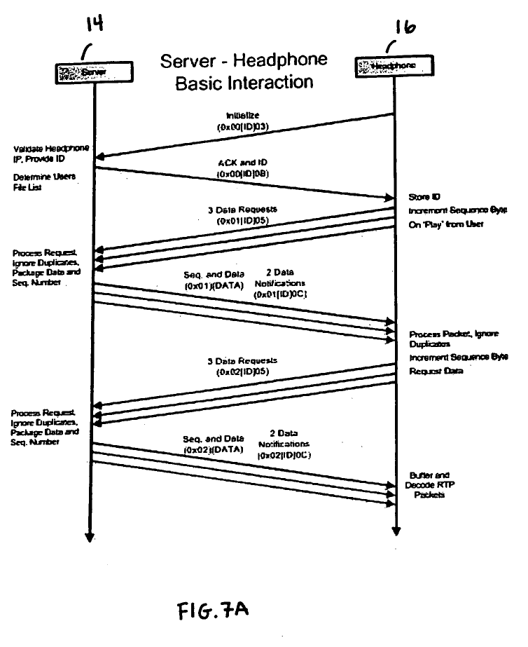

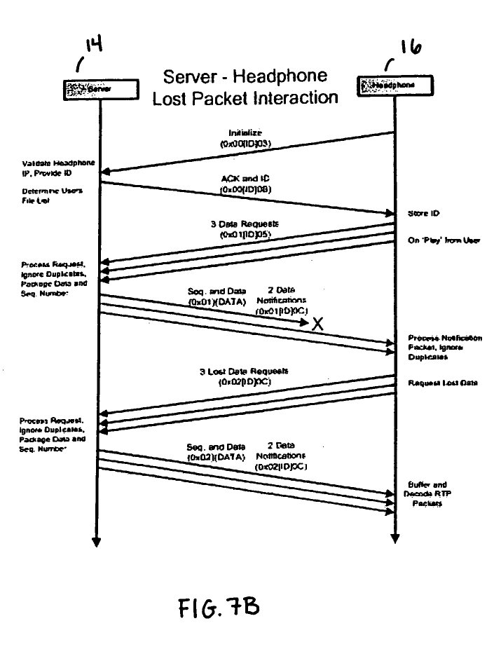

As shown in FIG. 7A and FIG. 7B, an exemplary receiving device (e.g., headphone)/server interaction includes local headphone ports/remote server ports 2221 and 2223. Port 2221 is a control port used to receive initiation and termination commands. Port 2223 is a data port used to receive MP3 frames.

An exemplary local server ports/remote headphone ports interaction includes a port 2200. Port 2200 includes all incoming requests from headphones. The server 14 also opens a new port for each headphone 16 to transmit MP3 data.

To establish a connection, the headphone 16 sends a setup request (0xXXXX03) packet to port 2200 on the server 14. Once the server 14 receives this setup request and validates the headphone IP address, the server 14 opens up a new port for MP3 data transmission to this specific headphone 16. The server 14 opens new ports for each of the headphones 16. The server 14 responds to the headphone's control port with its headphone ID, and setup acknowledgement command (0xXX[ID]05).

Once the headphone 16 completes its initialization process, it sends multiple MP3 Data Requests (0xXX[ID]05) on a ‘Play’ button press from the user. The server 14 will respond to this request with data packets to the headphone's data port. One packet of preset size will be sent per each request. The server 14 will also attach the current sequence number to the packet and send two notification packets to the control port.

Once data is received and validated on the headphone MP3 data port (2223), the host controller will process and send the MP3 data to the MP3 decoder.

When the headphone 16 needs more MP3 data, it requests another packet.

If the headphone 16 user wishes to take any action for playback, they can be implemented at any time. It may also terminate the stream at any point, by sending a request to terminate (0xXX[ID]07).

The server 14 can also terminate the stream at any point it wishes by sending the Server Terminate Stream request (0xXX[ID]09).

Due to the data request nature of the ASP protocol, if one data request control packet is dropped during the network transmission to the server 14, transmission of data packets will cease. To ensure the proper streaming rate, data request packets from the headphone 16 only occur once a data packet has been received. The stream therefore will stop.

In order to alleviate this problem, the headphone 16 will employ the use of sequence numbers and packet retransmission. Each time a data request packet is transmitted, an additional two packets will be transmitted immediately after. Each packet will contain a sequence number identifying that they were sent at the same time. The server 14 identifies the sequence number with a value that is different from preceding data request packet sequence number, the current packet will be accepted as a valid request packet. If all three packets having the same sequence number were received, the server 14 will ignore the second two packets whose sequence number is identical to the previously handled request packet. If the first data request packet was lost during transmission, the two subsequent packets still have a chance of being received and handled. The probability that the three redundant packets are lost is less that the probability that a signal packet is lost.

The sequence number is generated by the headphone 16 and has a minimum value of 0 and a maximum value of 222 (inclusive). The headphone 16 will increment through the sequence numbers for each unique data request. Once the maximum value of 222 has been reached, the sequence number will roll back to 0. The sequence number will be stored in the third byte of a control packet, where the first byte is the control command and the second byte is the server assigned to the headphone ID.

As mentioned above, data request packets are sent from the headphone 16 when a data packet has been received and during the initial stream setup process (after a server requests initialization). Therefore if a data packet is not received the subsequent data request is not sent to the server 14, and the stream will cease. It is impractical to transmit multiple, identical packets from the server 14 in hopes that one packet will be received. The headphones 16 must be notified when a data packet has been sent even if the data packet was not received by the headphone 16.

This is accomplished by sending several subsequent notification packets to the headphone control port after a data packet has been sent. The notification packet is the same form as a control packet with command (0x0C). If the data packet and the notification packets were all received, the headphone 16 would ignore the notification packets. If the data packet was not received but a notification packet was received, a ‘lost data request’ (0x0E) control packet is sent to the server 14. It is necessary to identify which notification packets belong to which data packets. If this is not done, the multiple notification packets sent with one data packet could trigger multiple data requests. This is avoided by placing the sequence number byte preceding the MP3 data payload in the data packet. The sequence number is also located in the notification packet. Notification packets with a sequence number equal to that of a received data packet are ignored.

Like the client 12, the server 14 can be implemented in a number of different programming languages. An object-oriented programming language is preferred, such as Java, C++, and Visual Basic. Visual Basic and C++ can be used on a Windows based system, whereas Java can be used on multiple platforms.

For the receiving devices 16, a development kit is needed that is capable of receiving a wireless audio file stream over a wireless network. There are many companies that produce development kits with this functionality, including TI, Allegro, and Iosoft.

There is a Microchip PIC18 microcontroller on the Iosoft ER22 development kit. This microcontroller is used to manipulate and control the incoming data over the wireless network. The PIC18 microcontroller can be programmed by using C or assembly.

The ER22 development kit requires a 9-volt power source. To provide this 9-volt source, a battery or a lab power supply can be used. In production, a battery is used because it is not practical for an end user to carry around a power supply. The power supply simulated the battery without continuously replacing dead batteries.

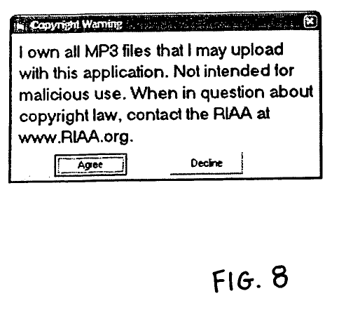

The client 12 begins by displaying a disclaimer as seen in FIG. 8. This message exists because the client 12 assumes that the end user selects only audio files (e.g., MP3 files) in which he or she has a legal copyright. This disclaimer is presented on an Accept/Decline basis. In order to proceed, the user must click on the “Accept” button. Clicking the “Decline” button or “x-ing” out of the program will result in the termination of client software. If “Accept” is selected, the client 12 will open the login window.

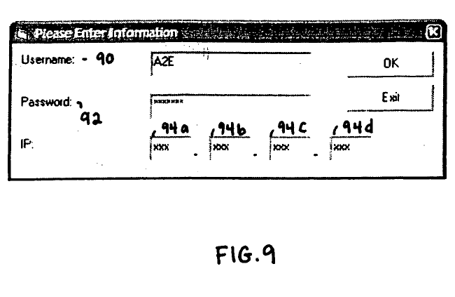

The login window in FIG. 9 provides six text fields. One field 90 contains the user entered ID. Another field 92 contains a masked password, again entered by the user. The remaining four fields 94a-d represent the IP address of the server. The initial IP address is set for the development server IP, but this can be changed on each execution of the client program.

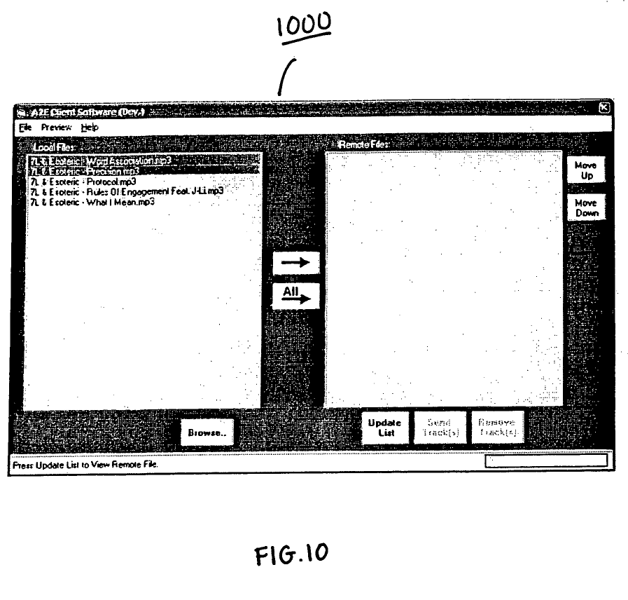

For production, these four fields 94a-d can be modified to one field where a domain name is entered, for example, www.ServerName.com. Once the “Ok” button is pressed, the client 12 attempts to log into the server's FTP. If the username or password is incorrect, the client 12 is not logged in. In the case of a successful login, the client 12 downloads the play list (mp3.txt) file from its directory on the server 14 and displays it in a main graphical user interface (GUI) 1000 (FIG. 10).

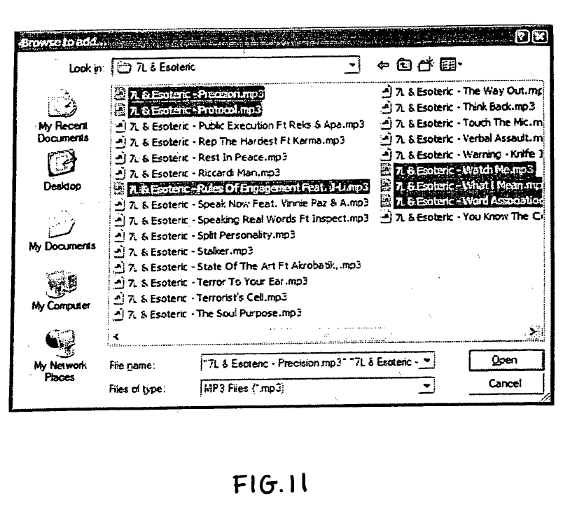

In order to add files to the server 14, the user first clicks the “Browse . . . ” button. This opens a common windows dialog box shown in FIG. 11. The box displays files, folders, and a directory listing. If the audio files are MP3 files, only MP3 files will be visible in this box. The user simply selects the MP3 files desired individually or by holding down either shift or control to multi-select files. Selecting “Open” will place all the selected files on the “Local Files” list of the client GUI.

More selections (e.g., tracks) can be added, or the user can select either the single arrow or the arrow labeled “All” to move files from the local to the “Remote Files” list. The remote list displays the queue of files to be uploaded to the server 14. To send the files, the “Send Track(s)” button is pressed. Pressing “Send Track(s)” causes a play list to be generated based on the remote files and uploads that play list along with the corresponding MP3 s. The filenames are removed from the remote list as they are completed. A progress bar located at the bottom right of the client 12 moves to convey to the user that the upload is still in progress. Once all the tracks are uploaded, the play list file is downloaded from the server 14 and displays its contents in the “Remote Files” list. “Update List” provides the function of downloading the remote play list and displaying them on the remote file list. “Update List” can be used at any time other than while an upload is in progress. “Remove Track(s)” may delete the selected remote files from the server 14 without confirmation. Removing tracks can occur at any time other than during an upload. The “Move Up” and “Move Down” buttons allow the user to move a single remote file up or down in the play list. This action takes effect only after sending the tracks. Even if no tracks are added, the “Send Track(s)” button is pressed to update the sent play list. The files are not re-uploaded if they are already present on the server 14, only the play list file will be overwritten.

The client software is the initial point of interaction for audio distribution. In this example system, the client software resides on a PC with a network connection. The client 12 provides both an input path of the music selection and an output of a graphical user interface (GUI) to the user. The GUI is responsible for displaying a disclaimer, providing the input locations for username and password, and a way to view or modify the play list. The client 12 processes the user's music selection of MP3 files into a play list. Using the keyboard, the user enters their unique username and password into the program to attempt a login. After a successful login, the transfer of the play list and corresponding MP3 files occurs from the client 12 to the server 14 using a File Transfer Protocol (FTP). The FTP portion of the server 14 provides the acknowledgement back to the client 12 along with the stored play list for synchronization. An open network connection is all that is needed for the client's network connection to properly function. Visual Basic provides the Application Programmers Interface (API) for sending data over FTP. There is an overall requirement of the client 12 that the maximum storage space is 1 Gigabyte. This limit is arbitrarily assigned and will vary from system to system. This is handled by configuring the FTP server to have a quota at the desired size. An error message is passed back to the client 12 if the quota is surpassed and the client 12 handles the error by alerting the user and exiting the program.

The GUI 1000 allows for interaction with the user who will provide a music selection. The selection of music is passed to the play list compiler where the data is parsed and a file, mp3.txt, is generated based on the MP3 file locations. Play list storage is the temporary storage location of the mp3.txt file. This file can be deleted upon exiting the client program. When the GUI is instructed to upload the files, the play list and audio file uploader take the mp3.txt file from the play list storage along with the MP3s, which are not moved from their initial location(s), and the login information provided by the user and upload them to the server 14. This data is passed to the Network Connection and sent using FTP. The Network Connection also provides a version of the remote play list as requested upon completion of the upload procedure. This play list information is passed back to the GUI 1000 for display.

The Play list Compiler is further broken down into the Play list, the MP3 File Location, the File Browser, and the MP3 Files. The inputted music selection from the GUI enters the File Browser, a Microsoft Windows Common Dialog, as an array of strings. Those strings are split such that the MP3 Files and their Locations may be appended to the Play list. The filenames are added one at a time to a temporary local version of mp3.txt. If the file titled “TestFile.mp3” was one of the selections, it would be entered into mp3.txt in the following way: “c:\Client\<username>\TestFile.mp3**”. The “**” informs the server 14 that the filename is complete. For each file selected, an entry into mp3.txt is appended defining the order of the list and all associated files. If no file exists, or the file is empty, no files are displayed in the Remote Files list of the GUI. Once the list is generated, it is passed to its temporary storage location, Play list Storage. The actual location of the temporary file is a hard drive of a computer. The file called mp3.txt on the client computer's hard drive is overwritten as needed. When the client program is exited, the local mp3.txt file is removed.

Until this point, all actions performed are local to the client's machine 12. The Play list and Audio file Uploader provide the data to the Network Connection so that all data is sent to the Server's FTP. The music and play list are passed into this block from the Play list Storage. This data, along with the Login Info provide the necessary information to complete an upload to the server 14. The login data is first used by the FTP program to verify the user is valid and to allow him or her to log in. Next, the play list, or mp3.txt, is uploaded followed by each of the audio file(s). Though this information is actually being passed to the network connection, it is the File Transfer Protocol that issues the commands and interprets the results. Upon completion of the upload in its entirety, the play list is downloaded from the network connection and passed back to the GUI for viewing and modification.

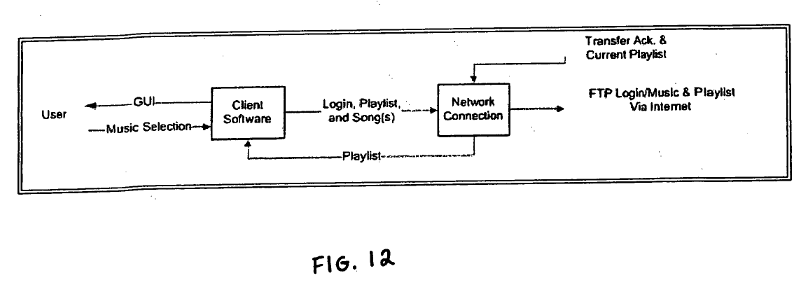

The server 14 can be a personal computer, which interacts with the client 12 module, the receiving devices 16, and an administrator. The interactions can be simultaneous. The server 14 includes a Card Reader or Keyboard 20, Server System and an 802.11b Wireless Access Point 22. FIG. 12 shows the hardware and the interaction with its users.

The server 14 receives and acknowledges music and play list transfers from the client 12 via an Internet Connection. The server 14 also responds back to the client's requests for the current play list. The administrator can input a user's ID in order to activate or deactivate their account with a headphone unit. The user's ID is entered from a card reader or keyboard 20. When users are active and streaming, the server 14 sends out the MP3 files to the wireless access point 22, which will send the information using the ASP definitions to the each appropriate Wireless Headphone 16 as dictated by the user's play list. The wireless access point 22 is capable of streaming over distances of greater than or equal to 50 ft. The server 14 also receives playback control requests coming through the access point 22 from each headphone 16 also defined by ASP. Upon receipt, it manipulates the MP3 stream accordingly.

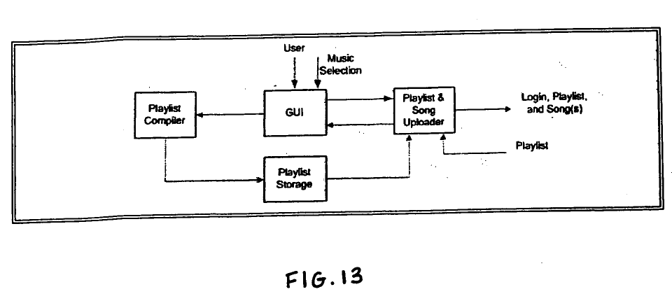

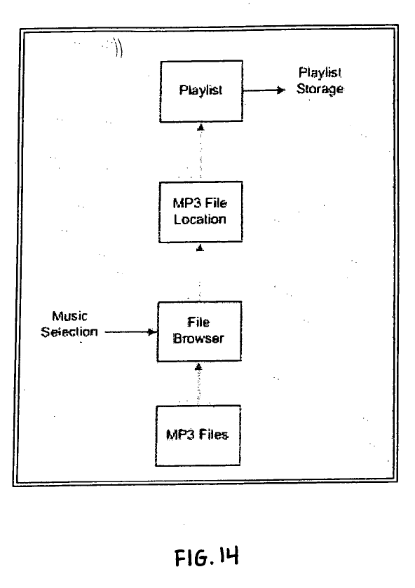

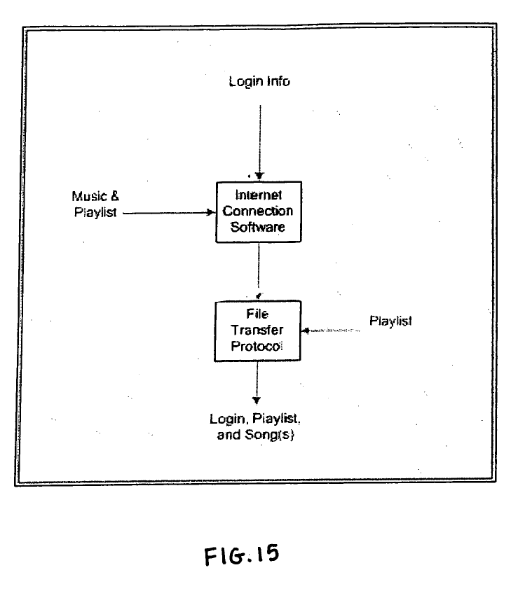

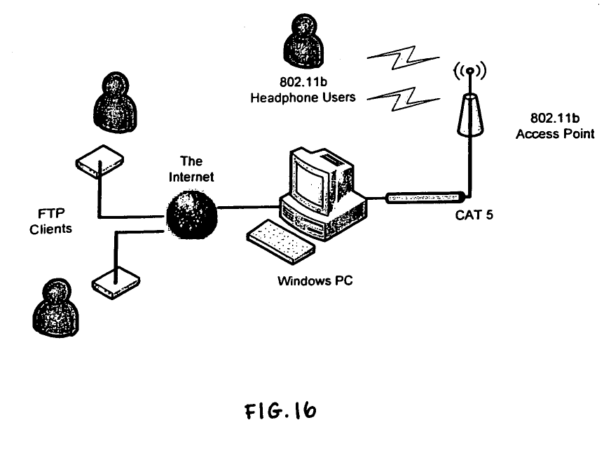

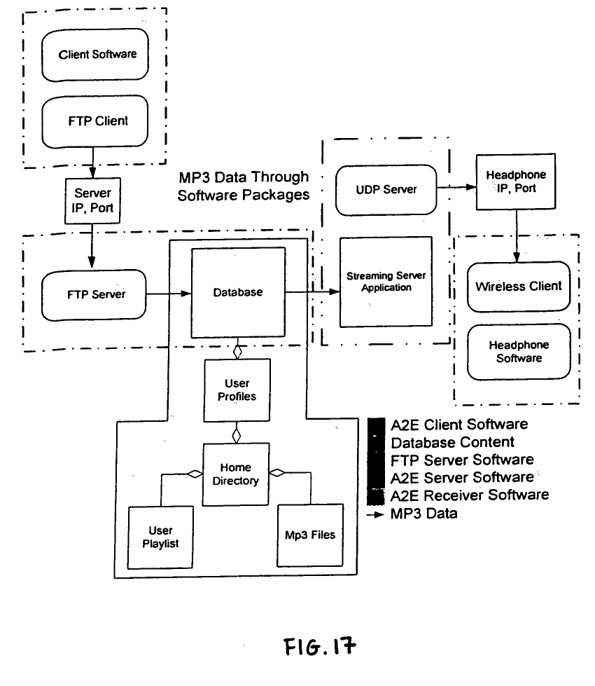

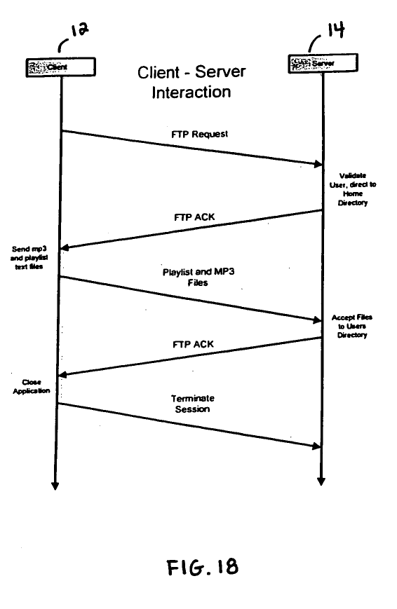

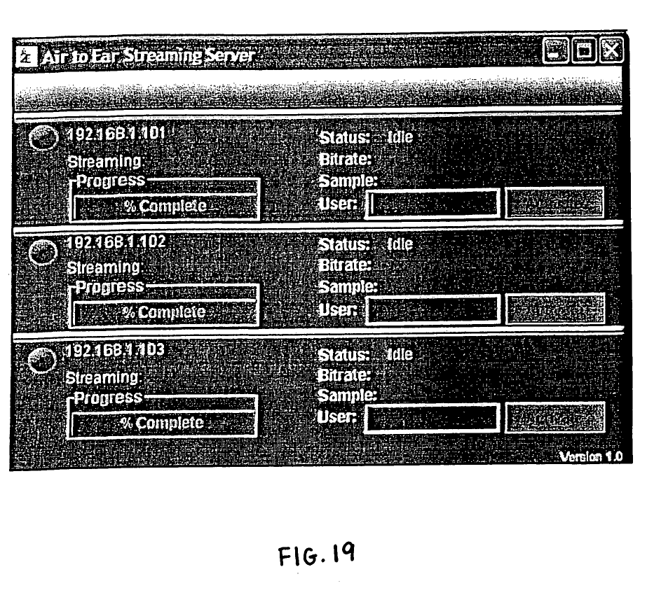

The server 14 is a combination of two methods, and a database. The first method is an FTP server application that accepts and services requests from the client 12 module. The second method is an application that streams MP3 files to the headphone units and accepts the playback control requests. FIGS. 13-19 show how the MP3 data flows from the client 12, to the server 14, and to the receiving devices 16. The FTP Server interacts with the Database Content, which is accessed by the Streaming Server.

The FTP server application package contains User Accounts and the File Transfer Protocol. The User Accounts contain information such as disk quota, password, and directory path. The package is set up as a server using the File Transfer Protocol (FTP). For this design, this package is implemented, for example, with Serv-U by RhinoSoft. The directory paths point to the User Directories where the User Play list and MP3 Files are stored. User Directories are limited to a file space of less than or equal to 1 GB, for example. As files are transferred over FTP, they are stored in the appropriate User Directory. All MP3 Files are supported by the FTP package.

The Streaming Server application package interacts with the administrator by way of a GUI which accepts User IDs and button actions from a keyboard. It also interacts with up to three receiving devices 16 simultaneously. This package is developed using Java based on the Windows XP/2000 platform.

In one particular embodiment, the server interface supports three receiving devices 16, each with its own information area. The IP address of the receiving devices 16 is located in the top left of each section, allowing the administrator see which receiving devices 16 are in use, or to activate one for the user. The status lights on the side indicate whether a receiving devices 16 is in use or not. In the ‘User:’ text box, a user's ID can be entered using a keyboard, and then activated by clicking on the activate button. This action associates the users play list and audio files with a receiving devices 16.

When receiving devices 16 are in use, many of the fields on the interface will update in real-time based on the users play list, playback control actions, and the current MP3 file being streamed. The figure shows user ID ‘Steve’ has been activated for the first headphone unit, but has not yet requested for a stream. The second headphone unit is in use by user ‘Joel’. His current MP3 filename is displayed next to “Streaming:” and his progress in real-time. Information about the MP3 such as its bit rate and sample rate is also displayed. Joel's stream can be terminated by pressing the deactivate button on the GUI or by receiving a terminate command from his headphones.

When a user is activated on the GUI, the User ID is sent to a Play list Handling routine which retrieves, parses, and stores that user's play list from the appropriate User Directory which is stored on the server PC machine. Play lists are text files that are stored in the user's directory. Since each play list uses the same format, other than the audio files that are listed, the Play list Handling routine can tokenize and generate a queue of the audio files for any user. Also when a user is activated, the Headphone Status becomes active, generating a queue to hold the user's first audio file (MP3 data) which is handled by a Queue Handling routine. The Queue Handler receives the user's MP3 Files specified from the head item in queue, which it received from the Play list Handler. It then will parse and queue the MP3 File into 1400 byte data chunks and package them into UDP datagrams and the appropriate ASP information to be sent over the wireless network to its specific headphone. Ultimately there are two queues, one containing the next audio files in the play list, the other containing the MP3 data of the current audio file.

Several steps are involved with parsing audio files, such as MP3 files, into data packets. For example, an MP3 file can contain an information tag (IDv3) or header, which contains information about the MP3 such as artist, title, length, and so forth. The Streaming Server can service all MP3 files including variable bit rate. The Queue Handler and also opens a dedicated UDP Data port to stream MP3 data to its specific active headphone using ASP Protocols described above. This protocol requires a header to be added to each of the datagrams before they are sent over the network. The addition of the header is performed in the Queue Handler as well. The ASP also specifies a control port that services incoming requests from all headphones on its local port 2200. All incoming requests are received on port 2200, but these requests are verified against the headphone's ID and only serviced if the Queue Handler is active for the requesting headphone 16. Each headphone 16 has a unique play list and file queues, which it manipulates during the streaming session. Because of this, unique streams are sent. Each headphone's queue becomes active or inactive based upon the actions from the GUI.

Incoming requests from headphones 16 are considered Playback Controls and come from the headphone user actions. When a request is received by the Control port, the request is evaluated. If the request is coming from an active headphone, the request is directed to the correct queue handler. For instance, if a ‘Next Track’ request came in from Joel's headphone in the example, his queue handler would flush its current queue of MP3 data, request the next file from the Play list Handler, parse the MP3 file, and continue to stream. The GUI would be updated accordingly.

The wireless headphones 16 are used to receive an MP3 stream over an 802.11b wireless network connection and playback this stream through a set of speakers. The headphones 16 are also capable of processing playback functions, such as next track, fast forward, and so forth.

In order to use the wireless headphones 16, a play list is associated with the headphone's unique ID. Once this occurs, the headphones 16 are powered up. The headphone 16 then waits in an idle state until the user presses the play button. When this occurs, a command is sent to the server 14 instructing it to initiate an MP3 stream. Protocol handshaking between the wireless headphones 16 and server 14 occurs. Once the initial handshaking is complete, MP3 data is streamed from the server 14 to the headphones 16. Arriving at the headphones 16, the MP3 data is buffered, decoded, and converted to an analog signal. From here the signal is sent to a set of speakers to produce a sound waveform.

The user has the option of altering the current stream by using the playback functions. These functions include play, stop, pause-resume, next track, previous track, fast forward, and rewind. Each of these functions has a push button which sends an ASP playback command to the server 14.

The Wireless Headphones 16 communicate with the server 14 using a Wireless Network Interface, which supports the 802.11b wireless local area network (WLAN) communication protocol. The Wireless Network Interface communicates wirelessly with the Server's Wireless Access Point 22. The 802.11b protocol, in conjugation with a wireless access point 22, is capable of supporting multiple users at ranges of greater than 50 feet. The use of an access point 22 generates an “infrastructure network.” The access point 22 is capable of delivering 11 Mbps of throughput; (sufficient for numerous 48 Kbps streams).

The Wireless Headphones' Network Interface is part of the Iosoft ER22 Wireless Development Kit. The Wireless Network Interface is controlled by the Host Controller.

The Host Controller controls the flow of data to and from the server 14. The Host Controller is also part of the Iosoft development kit. The microcontroller used is the Microchip PIC18F452. Programming the microcontroller is primarily done using the C programming language. This is accomplished by using the CCS C compiler. The compiler produces a HEX file containing the PIC machine code that implements the compiled C code. The HEX file is then flashed onto the microcontroller's program memory using the EPIC PIC programmer.

The microcontroller code is built on the Iosoft wireless network interface software. This software was used in addition to the development kit. The system includes drivers to interface the wireless network interface card with the PIC microcontroller. The system also includes basic protocol implementations. Included in these implementations is the Internet Protocol (IP). All communication occurs using the IP network layer. This layer is built on top of the IEEE 802.11b physical/data-link layer. In addition, the system includes an implementation of the User Datagram Protocol (UDP). Together the UDP and IP implementation make up the UDP/IP Stack. This stack includes C functions which perform actions pertaining to the UDP/IP communication. All network transactions require both source and destination address. The UDP/IP Stack therefore requires the unique Headphone ID in order to make network transactions. Because all network transactions are made over IP, the Headphone ID is a static IP address. Additionally, the unique IP address allows for unicast streaming.

The ASP streaming protocol is built on top of UDP in the UDP/ASP Routine. This is the core of the streaming system on the receivers side. Data requests are compiled by UDP/ASP Routine and are sent to the wireless network interface using the UDP/IP Stack. The received MP3 stream data is sent from the wireless network interface to the UDP/IP Stack. From here the UDP/ASP routine removes all protocol headers and sends the data to the MP3 Data Buffer located in the microcontroller's on-chip RAM. The data is then sent to the MP3 Decoder using the Serial Peripheral Interface (SPI) Routine. This routine implements the SPI serial bus on the PIC microcontroller. This bus is connected to the SPI bus of the MP3 Decoder. Due to the limited buffer memory (1534 bytes) and low clock speed (20 MHz) of the microcontroller described above, the transfer of MP3 data through the microcontroller is limited to 48 Kbps.

In a particular embodiment, the MP3 decoder is implemented using the STA013 MP3 Decoder from ST Electronics. The MP3 decoder chip contains a small buffer. When the buffer is roughly half full, a data request pin located on the MP3 decoder will go high. This pin is monitored by the host controller. Whenever the pin goes high, the host controller sends MP3 data to the MP3 decoder until the data request pin falls low. Once the host controller's buffer empties, more data is requested from the server by means of the ASP protocol. On a data request, the headphones issue three data requests. These requests have matching sequence numbers in the sequence field of the protocol. Once the server receives one of these data requests, it disregards the following requests of the same number. This provides for a light-weight, low traffic way to deal with dropped packets. Within the WLAN under the required range it is unlikely to lose packets, though some loss is possible. The probability of losing packets is low enough that the stream can resume under normal conditions.

The MP3 decoder outputs a Pulse Code Modulated (PCM) audio signal. This signal is fed to the Digital-to-Analog Converter (DAC) over an I2S serial bus. The MP3 decoder generates the necessary clock signals for DAC operation. The DAC outputs right and left analog audio signals. These signals are then sent to speakers to produce audible music.

The ER22 Wireless Development kit requires a 9-7.2 V power supply. The development kit regulates the power the input voltage to 5V for use on the development kit. The 5V power bus is also available to power components not located on the development kit, such as the MP3 decoder and DAC. The MP3 decoder requires a 3.3V supply. Therefore a 3.3V regulated voltage is generated for the STA013 use. The DAC requires a 5V supply. Level shifting circuitry is required to interface the 3.3V STA013 with the 5V PIC18 and CS4334.

The Power Source includes a battery and all necessary voltage regulation circuitry. While in operation, the Wireless Headphones circuit draws 300 mA. In order to satisfy the Endurance requirement, the battery is required to store at least 600 mA of charge.

Additional software routines on the Host controller communicate with the MP3 Decoder. The MP3 Decoder I2C Routine sends all configuration parameters to the MP3 Decoder over the Integrated Circuit bus (I2C). These parameters are sent during initialization and when a playback button is pressed. When the headphones are powered by the Power Source, the microcontroller's Power-Up Sequence initiates program code execution. The first block of code executed is the Initialization Routine. This routine is responsible for initializing the MP3 decoder interface. MP3 Decoder initialization includes writing 2007 registers with preset values. When a playback button is pressed, the Playback Pushbutton Handler instructs the MP3 I2C Routine to flush the MP3 decoder's internal buffer and change its decoding state. Additionally, the Playback Pushbutton Handler instructs the UDP/ASP Routine to send the appropriate ASP playback command to the server.

The Playback Pushbutton Handler responds to a change in the playback button states by polling input pins. The playback buttons and accompanying circuitry make up the Playback Controls. The buttons state is encoded using a priority encoder and input to the microcontroller through the standard I/O pins.

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention has been described in terms of particular embodiments. Other embodiments are within the scope of the following claims.

1. A protocol for communicating between an audio receiver and a server located in a local area network (LAN) comprising:
an 8-bit sequence number field;
an 8-bit audio receiver identification field; and,
an 8-bit command field, the command bit including a 4-bit options field and a 4-bit command field.

2. The protocol of claim 1 wherein the sequence number field handles packet loss, duplicate control packets, out-of-band negative acknowledgments (NAKs), and retransmission of media data packets.

3. The protocol of claim 1 wherein the audio receiver identification is used for the server to offer multiple audio receivers with individual media streams.

4. The protocol of claim 1 wherein the 4-bit command field includes receiver setup commands, receiver playback function commands and data transfer commands.

5. The protocol of claim 1 wherein the 4-bit command field is a five second skip forward command.

6. The protocol of claim 1 wherein the 4-bit command field is an initialize receiver command.

7. The protocol of claim 1 wherein the 4-bit command field is a five second skip backward command.

8. The protocol of claim 1 wherein the 4-bit command field is a data request command.

9. The protocol of claim 1 wherein the 4-bit command field is a next track command.

10. The protocol of claim 1 wherein the 4-bit command field is a receiver terminate stream command.

11. The protocol of claim 1 wherein the 4-bit command field is a previous track command.

12. The protocol of claim 1 wherein the 4-bit command field is a server terminate stream command.

13. The protocol of claim 1 wherein the 4-bit command field is a pause/resume command.

14. The protocol of claim 1 wherein the 4-bit command field is a server initiate sequence command.

15. The protocol of claim 1 wherein the 4-bit command field is a data request notification command.

16. The protocol of claim 1 wherein the 4-bit command field is a lost packet notification command.

17. A system comprising:
multiple audio receivers;
multiple clients, each of the clients uploading a set of audio files to a server; and
the server maintaining multiple sets of audio files and generating multiple streams of the audio files to the multiple audio receivers over a wireless interface using a streaming protocol.

18. The system of claim 17 wherein the multiple audio receivers include low processor speed and small memory size.

19. The system of claim 17 wherein the multiple clients communicate with the server to manipulate media under individual accounts.

20. The system of claim 17 wherein the server includes an Internet connection to communicate with the multiple clients and a wireless local area network (LAN) to communicate with the multiple audio receivers.

21. The system of claim 20 wherein the server further includes processes to maintain the audio files and play lists for users.

22. The system of claim 17 wherein the server resides in a local area network.

23. A system comprising:
a server, the server streaming audio files to multiple different specific low memory and low speed devices over a wireless interface using a streaming protocol.

24. The system of claim 23 wherein the devices are portable listening devices.

25. The system of claim 23 wherein the devices include a small amount of memory or buffer space.
